(19) United States
(12) Patent Application Publication
(10) Pub. No.: US 2014/0344728 A1
(43) Pub. Date: Nov. 20, 2014

(54) METHOD AND APPARATUS FOR GENERATING CONTEXT-BASED FUNCTIONAL ICONS

(71) Applicant: HERE Global B.V., Veldhoven (NL)

(72) Inventor: Marko Tapio Tuukkanen, Schlenzer (DE)

(73) Assignee: HERE Global B.V., Veldhoven (NL)

(21) Appl. No.: 13/896,614

(22) Filed: May 17, 2013

(51) Int. Cl. G06F 3/0481

(52) U.S. Cl. CPC G06F 3/04817
USPC 715/763

(57) ABSTRACT

An approach is provided for generating functional icons on one or more devices based on the location of one or more users relative to a user's vehicle, the time that the one or more users are away from the vehicle, and/or the specific location of the one or more users and/or the user's vehicle. A context platform causes, at least in part, an evaluation of one or more contextual parameters against one or more threshold criteria, wherein the contextual parameters are associated with at least one vehicle, at least one user of the at least one vehicle, or a combination thereof. The context platform causes, at least in part, a generation of at least one interactive user interface element depicting information related to the at least one vehicle based, at least in part, on the evaluation. The context platform causes, at least in part, a presentation of the at least one interactive user interface element in at least one user interface of at least one device.

### BACKGROUND

Service providers and device manufacturers (e.g., wireless, cellular, etc.) are continually challenged to deliver value and convenience to consumers by, for example, providing compelling network services. One area of interest has been the development of location-based services to provide users of mobile devices (e.g., a mobile phone and/or a tablet) with assistant services to improve the quality of their travels, particularly while driving. Often, after some passage of time (e.g., time spent shopping, relaxing at a beach, etc.), a user may have difficulty remembering where he or she parked his or her vehicle (e.g., parking the vehicle in a large shopping mall parking lot, an unfamiliar city street, etc.). In addition, the vehicle may have been moved and/or parked by a family member or a close friend that shares and/or has access to the vehicle and the user is unaware of the vehicle's current location. Assistant services have been previously developed using functional icons or live tiles to provide a user with navigation assistance to his or her parked vehicle. A functional icon is an interactive user interface element that can present real-time information on a start screen or home screen of a mobile device (e.g., news, weather, sports, social networking status updates, a car location, etc.). However, these services do not generate a functional icon on one or more devices associated with one or more users based on an evaluation of one or more contextual parameters such as the location of the one or more users relative to a user's vehicle, the time that the one or more users are away from the vehicle, and/or the specific location of the one or more users and/or the user's vehicle (e.g., a home location versus a large parking lot). Accordingly, service providers and device manufacturers face significant technical challenges in providing a service that generates and removes context-based functional icons showing vehicle related information.

### SOME EXAMPLE EMBODIMENTS

Therefore, there is a need for an approach for generating functional icons (e.g., a live tile) on one or more devices based on the location of one or more users relative to a user's vehicle, the time that the one or more users are away from the vehicle, and/or the specific location of the one or more users and/or the user's vehicle.

According to one embodiment, a method comprises causing, at least in part, an evaluation of one or more contextual parameters against one or more threshold criteria, wherein the one or more contextual parameters are associated with at least one vehicle, at least one user of the at least one vehicle, or a combination thereof. The method also comprises causing, at least in part, a generation of at least one interactive user interface element depicting information related to the at least one vehicle, the at least one user, or a combination thereof based, at least in part, on the evaluation. The method further comprises causing, at least in part, a presentation of the at least one interactive user interface element in at least one user interface of at least one device.

According to another embodiment, an apparatus comprises at least one processor, and at least one memory including computer program code for one or more computer programs, the at least one memory and the computer program code configured to, with the at least one processor, cause, at least in part, the apparatus to cause, at least in part, an evaluation of one or more contextual parameters against one or more threshold criteria, wherein the one or more contextual parameters are associated with at least one vehicle, at least one user of the at least one vehicle, or a combination thereof. The apparatus also causes, at least in part, a generation of at least one interactive user interface element depicting information related to the at least one vehicle, the at least one user, or a combination thereof based, at least in part, on the evaluation. The apparatus further causes, at least in part, a presentation of the at least one interactive user interface element in at least one user interface of at least one device.

According to another embodiment, a computer-readable storage medium carries one or more sequences of one or more instructions which, when executed by one or more processors, cause, at least in part, an apparatus to cause, at least in part, an evaluation of one or more contextual parameters against one or more threshold criteria, wherein the one or more contextual parameters are associated with at least one vehicle, at least one user of the at least one vehicle, or a combination thereof. The apparatus also causes, at least in part, a generation of at least one interactive user interface element depicting information related to the at least one vehicle, the at least one user, or a combination thereof based, at least in part, on the evaluation. The apparatus further causes, at least in part, a presentation of the at least one interactive user interface element in at least one user interface of at least one device.

According to another embodiment, an apparatus comprises means for causing, at least in part, an evaluation of one or more contextual parameters against one or more threshold criteria, wherein the one or more contextual parameters are associated with at least one vehicle, at least one user of the at least one vehicle, or a combination thereof. The apparatus also comprises means for causing, at least in part, a generation of at least one interactive user interface element depicting information related to the at least one vehicle, the at least one user, or a combination thereof based, at least in part, on the evaluation. The apparatus further comprises means for causing, at least in part, a presentation of the at least one interactive user interface element in at least one user interface of at least one device.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of generating functional icons on one or more devices based on the location of one or more users relative to a user's vehicle, the time that the one or more users are away from the vehicle, and/or the specific location of the one or more users and/or the user's vehicle, according to one embodiment;

FIG. 2 is a diagram of the components of a context platform, according to one embodiment;

FIGS. 3-5 are flowcharts of processes for generating functional icons on one or more devices based on the location of one or more users relative to a user's vehicle, the time that the one or more users are away from the vehicle, and/or the specific location of the one or more users and/or the user's vehicle, according to one embodiment;

FIGS. 6A and 6B are ladder diagrams that illustrate processes for generating functional icons on one or more devices based on the location of one or more users relative to a user's vehicle, the time that the one or more users are away from the vehicle, or a combination thereof, according to one embodiment, according to various embodiments;

FIG. 7 is a diagram of user interfaces utilized in the processes of FIGS. 3-5, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for generating functional icons on one or more devices based on the location of one or more users relative to a user's vehicle, the time that the one or more users are away from the vehicle, and/or the specific location of the one or more users and/or the user's vehicle are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

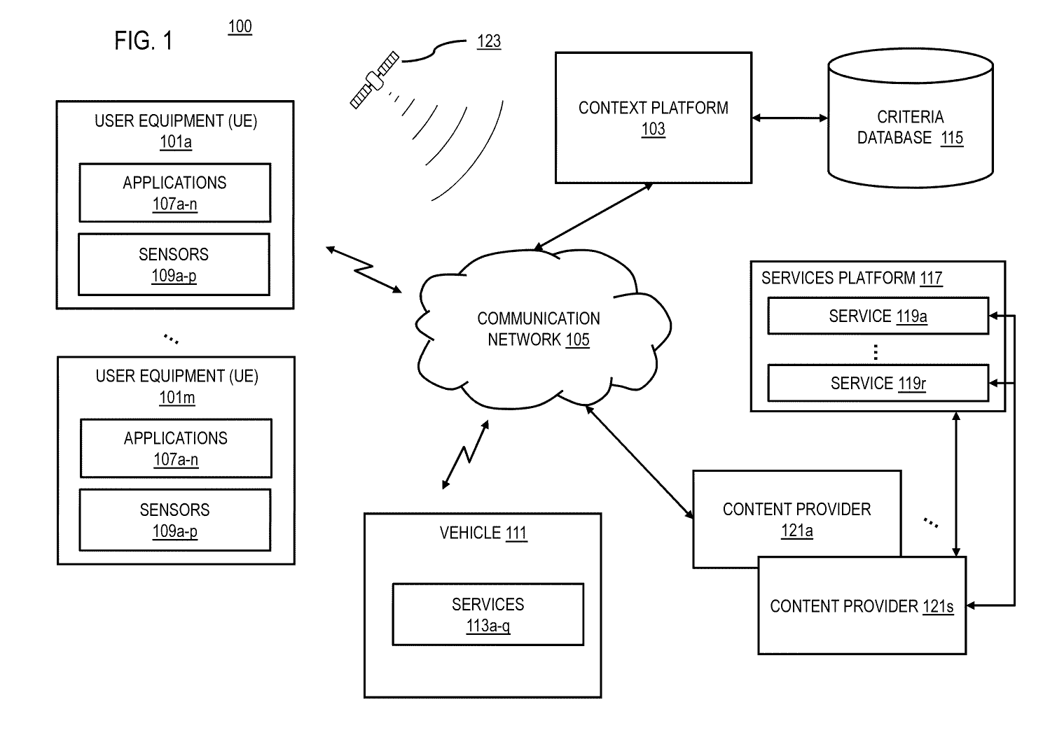

FIG. 1 is a diagram of a system capable of generating functional icons on one or more devices based on the location of one or more users relative to a user's vehicle, the time that the one or more users are away from the vehicle, and/or the specific location of the one or more users and/or the user's vehicle, according to one embodiment. As previously discussed, one area of interest among service providers and device manufacturers has been the development of location-based services to provide users of mobile devices with assistant services to improve the quality of their travels, particularly while driving. Often, after the passage of time (e.g., time spent shopping, relaxing at a beach, etc.) a user may have difficulty remembering where he or she parked his or her vehicle (e.g., parking a vehicle in a large shopping mall parking lot, an unfamiliar city street, etc.). In addition, the vehicle may have been moved and/or parked by a family member or a close friend that shares and/or has access to the vehicle and the user is unaware of the vehicle's current location. Assistant services have been previously developed using functional icons or live tiles to provide a user with navigation assistance to his or her parked vehicle. However, these services do not generate a function icon or live tile on one or more devices associated with one or more users based on an evaluation of one or more contextual parameters such as the location of the one or more users relative to a user's vehicle, the time that the one or more users are away from the vehicle, and/or the specific location of the one or more users and/or the user's vehicle (e.g., a user's driveway versus a mall parking lot).

To address this problem, a system 100 of FIG. 1 introduces the capability to generate functional icons on one or more devices based on the location of one or more users relative to a user's vehicle, the time that the one or more users are away from the vehicle, and/or the specific location of the one or more users and/or the user's vehicle, according to one embodiment. As shown in FIG. 1, the system 100 comprises one or more user equipment (UE) 101a-101m (e.g., mobile phones and/or tablets) (also collectively referred to as UEs 101) having connectivity to a context platform 103 via a communication network 105. The UEs 101 also include or have access to one or more applications 107a-107n (also collectively referred to as applications 107). By way of example, the applications 107 may include mapping and/or navigation applications, mobile payment applications, location-based applications (e.g., enabling location “check-ins”), a weather application, an Internet browser, social networking applications, etc. In addition, the UEs 101 include one or more sensors 109a-109p (also collectively referred to as sensors 109). In particular, the sensors 109 may include, for example, a global positioning system (GPS) receiver, a compass, a magnetometer, an accelerometer, or a combination thereof. The system 100 also includes at least one vehicle 111 (e.g., a car) including or having access to one or more services 113a-113q (also collectively referred to as services 113) having connectivity to the context platform 103 via the communication network 105. More specifically, the services 113 (e.g., a communication service, a navigation service, or a combination thereof) enable the vehicle 111 to notify the context platform 103 of its location, the status of one or more systems associated with the vehicle 111 that can be used by the system 100 to verify the at least one user's presence near the vehicle 111 (e.g., unlocked locks, powered lights, a running engine, etc.).

In one embodiment, the context platform 103 may include or be associated with at least one criteria database 115. In one example embodiment, the context platform 103 may exist in whole or in part within a UE 101, or independently and the at least one criteria database 115 may exist in whole or in part within the context platform 103. The at least one criteria database 115 may include, at least in part, one or more lists of one or more threshold criteria such as a minimum distance between the at least one user and the vehicle 111 (e.g., 50-100 meters), a minimum amount of time for the at least one user to exceed the minimum distance (e.g., 5 minutes), a minimum distance between the location of the at least one vehicle and another location (e.g., when the vehicle is moved by one or more users), a location previously associated with the at least one user (e.g., a home location, a reserved parking space at work, and/or where the at least one user has parked the vehicle 111a number of times in the past), a state of the one or more systems associated with the at least one vehicle (e.g., unlocked doors), a low visibility time of day (e.g., during the nighttime), a low visibility weather condition (e.g., during fog, heavy rain, snow, etc.), the visual complexity of an area (e.g., specific geometrical, architectural, and/or landscape-based details), etc.

The UEs 101 are also connected to a services platform 117 via the communication network 105. In one embodiment, the services platform 117 includes one or more services 119a-119r (also collectively referred to as services 119). The services 119 may include a wide variety of services such as content provisioning services for one or more of the applications 107, the services 113, or a combination thereof. By way of example, the services 119 may include mapping and/or navigation services, a cloud-based service, a single sign-on service, transportation services (e.g., a service providing schedules and/or timetables for taking a shuttle bus to a parked vehicle), weather-based services, social networking services, etc. In one embodiment, the UEs 101, the services platform 117, and the services 119 also have connectivity to one or more content providers 121a-121s (also collectively referred to as content providers 121). The content providers 121 also may provision a wide variety of content (e.g., maps, navigation routes, etc.) to the components of the system 100.

In one embodiment, the context platform 103, the applications 107 (e.g., a mapping and/or navigation application), or a combination thereof may utilize one or more location-based technologies (e.g., GPS, cellular triangulation, Assisted GPS (A-GPS), etc.) to determine a location of a UE 101 (e.g., 50 meters from the vehicle 111), to make a request to one or more services 119 for location-based data (e.g., mapping and/or navigation information) based on a position relative to a UE 101, or a combination thereof. For example, a UE 101 may include a GPS receiver to obtain geographic coordinates from the satellites 123 to determine its current location.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UEs 101 are any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UEs 101 can support any type of interface to the user (such as “wearable” circuitry, etc.).

In one embodiment, the system 100 determines one or more credentials associated with at least one vehicle (e.g., the vehicle 111), at least one device (e.g., a UE 101), at least one user of the at least one vehicle, one or more other users (e.g., a family member or close friend of the at least one user that shares and/or has access to the at least one vehicle), or a combination thereof. By way of example, the at least one device may refer to a mobile device or a UE 101 associated with the at least one user (e.g., the owner of the at least one vehicle) as well as a mobile device or a UE 101 associated with one or more other users (e.g., a family member or close friend that shares and/or has access to the at least one vehicle). By way of example, at least one user can register the one or more credentials (e.g., a username and password) associated with at least one vehicle and at least one device (e.g., a mobile phone or a tablet) on a single sign-on service that enables a user to access an email account, various applications and/or services, etc. and the system 100 can thereafter determine that the at least one vehicle and the at least one device are “paired.” In addition, the at least one user can also register one or more credentials of one or more other users that may also use the at least one vehicle from time to time.

In one or more embodiments, the system 100 determines one or more contextual parameters based, at least in part, on at least one notification by the at least one vehicle (e.g., the vehicle 111), one or more sensors (e.g., a sensor 109) associated with at least one device (e.g., a UE 101), or a combination thereof. By way of example, the one or more contextual parameters may include, at least in part, the location of the at least one vehicle, the location of the at least one user and/or the at least one device associated with the at least one user (e.g., a UE 101), the amount of time that the at least one user has spent apart or away from the at least one vehicle, the status information associated with the at least one vehicle (e.g., a lock status, a light status, an engine status, etc.), or a combination thereof. In one embodiment, the at least one notification includes, at least in part, the location of the at least one vehicle (e.g., based on GPS coordinates), the status information (e.g., doors unlocked), or a combination thereof. For example, when the at least one user parks the at least one vehicle, the vehicle, one or more services associated with the vehicle (e.g., a communication service, a navigation service, or a combination thereof), or a combination thereof can notify the system 100 of the vehicle's location (e.g., parked within a large shopping mall parking lot) and its status (e.g., doors locked) via the communication network 105. In one embodiment, the at least one vehicle, the one or more services associated with the at least one vehicle, or a combination thereof can also notify the system 100 of a change in the status of one or more systems associated with the at least one vehicle and thereby verify the presence of the at least one user near the at least one vehicle. For example, when the at least one user is in visual distance of the at least one vehicle, he or she may remotely unlock the vehicle's doors and/or start the vehicle's engine.

In one embodiment, the system 100 can determine the location of the at least one user and how long he or she has been away from the at least one vehicle based, at least in part, on the one or more sensors associated with the at least one device (e.g., a GPS receiver). For example, in terms of time, the system 100 can determine whether the at least one user has been away from the at least one vehicle for a considerable amount of time (e.g., while shopping in a shopping mall) or for a short period of time (e.g., running into a convenience store to make a quick purchase before getting back into the at least one vehicle).

In one embodiment, the system 100 causes, at least in part, an evaluation of one or more contextual parameters against one or more threshold criteria, wherein the one or more contextual parameters are associated with at least one vehicle (e.g., the vehicle 111), at least one user of the at least one vehicle (e.g., the owner of the at least one vehicle and/or one or more family members or close friends that share and/or have access to the at least one vehicle), or a combination thereof. By way of example, the one or more user defined threshold criteria may include, at least in part, a minimum distance between the at least one vehicle and at least one user (e.g., 50-100 meters), a minimum amount of time for the at least one user to exceed the minimum distance (e.g., over 5 minutes), a minimum distance between the location of the at least one vehicle and another location (e.g., if the vehicle is moved by one or more other users), a location previously associated with the at least one user (e.g., a home location), a state of the one or more systems associated with the at least one vehicle (e.g., unlocked doors), a low visibility time of day, a low visibility weather condition, the visual complexity of an area, etc. Accordingly, in one embodiment, the system 100 evaluates whether the location of at least one user relative to the location of the at least one vehicle, the amount of time that the at least one user has exceeded the minimum distance, and/or the distance between the location of the at least one vehicle and another location exceeds the predetermined minimum values of the one or more threshold criteria.

By way of example, in one example use case, the system 100 can determine that at least one user has parked the at least one vehicle in a parking garage, but he or she remains within the minimum distance (e.g., the user takes an elevator one or more floors up or down from the vehicle). In this example use case, based, at least in part, on the evaluation of the one or more contextual parameters against the one or more threshold criteria (e.g., distance), the system 100 will initially not cause, at least in part, a generation of the at least one interactive user interface element. However, in this example, the system 100 can also determine based, at least in part, on the visual complexity of the area that the at least one user is located in a complex parking garage and therefore may have difficulty easily navigating back to the at least one vehicle. As a result, the system 100 will cause, at least in part, a generation of the at least one interactive user interface element notwithstanding the initial evaluation. Similarly, in another example use case, the at least one vehicle may be parked on one side of a river by a family member or friend and the at least one user (e.g., the owner of the vehicle) may require navigation assistance to reach the vehicle even though the distance between the at least one user and the at least one vehicle is within the minimum distance (e.g., within 50-100 meters). Moreover, in one embodiment, the system 100 can determine to reduce the minimum distances of one or more threshold criteria when the system 100 determines one or more low visibility conditions are present (e.g., during the nighttime, fog, heavy rain, snow, etc.) based, at least in part, on a weather-based application and/or service.

In one or more embodiments, the system 100 causes, at least in part, a generation of at least one interactive user interface element (e.g., a functional icon, a live tile, a widget, etc.) depicting information related to the at least one vehicle (e.g., the location of the at least one vehicle), the at least one user, or a combination thereof based, at least in part, on the evaluation of the one or more contextual parameters against one or more threshold criteria. In particular, it is contemplated that the one or more threshold criteria ensures that the system 100 does not generate an interactive user interface element in contexts where it is likely that the at least one user already knows and/or can see where he or she parked his or her vehicle (e.g., after running into a convenience store to only purchase a newspaper, walking away and then remembering something was left in the vehicle that is needed, etc.). By way of example, if the system 100 determines that the at least one user has exceeded one or more threshold criteria (e.g., being over 50-100 meters away from the at least one vehicle for over 5 minutes), the system 100 can automatically cause, at least in part, the generation of the at least one interactive user interface element (e.g., a functional icon or a live tile). In contrast, if the system 100 determines that the at least user is sufficiently far away from the at least one vehicle, but leaves the doors unlocked (e.g., while stopping by a kiosk to buy a newspaper), then the system 100 will not cause, at least in part, a generation of the at least one interactive user interface element since it is presumed that the at least one user is returning to his or her vehicle shortly and is unlikely to require navigation assistance. In this example use case, if the system 100 determines, however, that the at least one user is gone for an extended amount of time (e.g., more than 10 minutes), then the system 100 can cause, at least in part, a generation of the at least one interactive user interface element and potentially notify the at least one user that his or her vehicle's doors are unlocked. In one embodiment, the at least one interactive user interface element may include, at least in part, a map view, an address view, a picture view, or a combination thereof of the at least one vehicle and the one or more views can be interchangeable (e.g., based on a user preference). In one embodiment, it is contemplated that the at least one interactive user interface element may also include the remaining parking time if the maximum parking time is defined at the parking location and/or the current parking payment if a mobile parking payment is used.

In certain embodiments, the system 100 determines whether to generate the at least one interactive user interface element (e.g., a functional icon or a live tile) based, at least in part, on whether the at least one threshold criteria has been previously associated with the at least one user. By way of example, if the system 100 determines that the at least one user has parked the at least one vehicle 10 or more times, for example, in this same location (e.g., based on one or more lists stored in the criteria database 115), then the system 100 will not cause, at least in part, the generation of the at least one interactive user interface element because it is contemplated that the user is likely to remember where he or she parked his or her vehicle. More specifically, the association information is only valid for that specific user. For example, when the system 100 determines that user “A” has parked the at least one vehicle at his or her home location, the system 100 will not cause, at least in part, the generation of the at least one interactive user interface element. However, when the system 100 determines that a user “B” (e.g., a friend that has access to the vehicle) parks the at least one vehicle at the same location, the system 100 can cause, at least in part, the generation of the at least one interactive user interface element on the at least one device of user “B”.

In one embodiment, the system 100 causes, at least in part, a presentation of the at least one interactive user interface element (e.g., a functional icon or a live tile) in at least one user interface of at least one device (e.g., a display of a UE 101). By way of example, the system 100 can cause, at least in part, the presentation of the at least one interactive user interface element on a start screen or home screen of the at least one mobile device (e.g., a mobile phone or a tablet). In one embodiment, the system 100 can cause, at least in part, a presentation of the at least one interactive user interface element in each device “paired” with the at least one vehicle. By way of example, if the system 100 determines that the at least one user (e.g., user “A”) is standing next to the at least one vehicle, then the system 100 will not cause, at least in part, the presentation of the at least one interactive user interface element on his or her device. However, if the system 100 also determines that one or more other users (e.g., user “B” that shares and/or has access to the at least one vehicle) has walked past the minimum distance away from the at least one vehicle for the minimum time, then the system 100 will cause, at least in part, the presentation of the at least one interactive user interface element in at least one user interface of at least one device of user “B”. In one embodiment, the system 100 can also enable the at least one user to manipulate the size and/or location of the at least one interactive user interface element on the at least one user interface (e.g., by tapping or sliding the at least one interactive user interface element).

In one embodiment, the system 100 causes, at least in part, a presentation of at least one mapping interface (e.g., a mapping and/or navigation application 107) depicting the location of the at least one vehicle (e.g., the vehicle 111) based, at least in part, on at least one interaction with the at least one interactive user interface element (e.g., tapping or long pressing the functional icon or live tile). By way of example, the system 100 can cause, at least in part, the at least one mapping interface to present to the at least one user various alternatives to reach the at least one vehicle (e.g., walking or taking a shuttle bus depending on the distance). In one embodiment, the system 100 can also cause, at least in part, the at least one mapping interface to present to the at least one user public transportation or drive navigation assistance to the at least one vehicle (e.g., if the at least one vehicle has been moved by the one or more other users and is no longer near the at least one user).

In one or more embodiments, the system 100 causes, at least in part, a removal of the at least one interactive user interface element from the at least one user interface based, at least in part, on the evaluation (e.g., the at least one user being within or outside of the one or more criteria thresholds), status information associated with the at least one vehicle (e.g., a lock status, a light status, an engine status, or a combination thereof), or a combination thereof. By way of example, if the system 100 determines that the one or more contextual parameters (e.g., the distance between the at least one user and the at least one vehicle) is less than the one or more threshold criteria (e.g., 50-100 meters), then the system 100 can automatically remove the at least one interactive user interface element (e.g., a functional icon or a live tile) from the at least one user interface of the at least one device (e.g., a start screen or home screen of a mobile phone or a tablet). In one embodiment, it is contemplated that even if the system 100 determines that the at least one user has closed the at least one mapping interface (e.g., while going into a shop) and/or has returned to the start screen or home screen, for example, the at least one interactive user interface element will remain in the at least one user interface of the at least one device.

In one embodiment, the system 100 can cause, at least in part, a generation of at least one notification on the at least one device (e.g., a UE 101) that the at least one user is near the at least one vehicle (e.g., the vehicle 111) based, at least in part, on the evaluation. By way of example, the at least one notification may include a visual prompt, an audio prompt, a haptic prompt (e.g., a vibration), or a combination thereof. In one example use case, the system 100 can notify the at least one user that he or she has arrived at his or her vehicle and can then cause, at least in part, the at least one mapping interface to close since the navigation assistance is no longer needed by the at least one user.

In one or more embodiments, the system 100 causes, at least in part, at least one update of the one or more contextual parameters based, at least in part, on one or more other users (e.g., a family member or close friend of the at least one user) moving the at least one vehicle (e.g., the vehicle 111). In one example use case, once the at least one user parks the at least one vehicle (e.g., in a large office complex parking lot), the system 100 can determine a notification from the at least one vehicle including, at least in part, the location of the vehicle. The system 100 then evaluates and determines whether the one or more contextual parameters (e.g., a distance and a time) exceed the one or more threshold criteria (e.g., 50-100 meters and 5 minutes, respectively). If so, then the system 100 causes, at least in part, the generation of the at least one interactive user interface element (e.g., a functional icon or a live tile) on the at least one user interface of the at least one device of the at least one user (e.g., on a start screen of the user's mobile phone or tablet). After some time, the system 100 may determine one or more credentials of one or more other users and/or that the minimum distance between the initial location of the at least one vehicle and another location of the at least one vehicle has been exceeded (e.g., the at least one vehicle has been moved by the one or more users). Consequently, the system 100 can cause, at least in part, the removal of the at least one interactive user interface element from the at least one device of the at least one user and once the one or more other users park the at least one vehicle, the system 100 can update the one or more contextual parameters and restart the process disclosed herein (i.e., substituting the one or more users for the at least one user).

By way of example, the UEs 101, the context platform 103, the application 107, the sensors 109, the vehicle 111, the services 113, the criteria database 115, the services platform 117, the services 119, the content providers 121, and the satellites 123 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

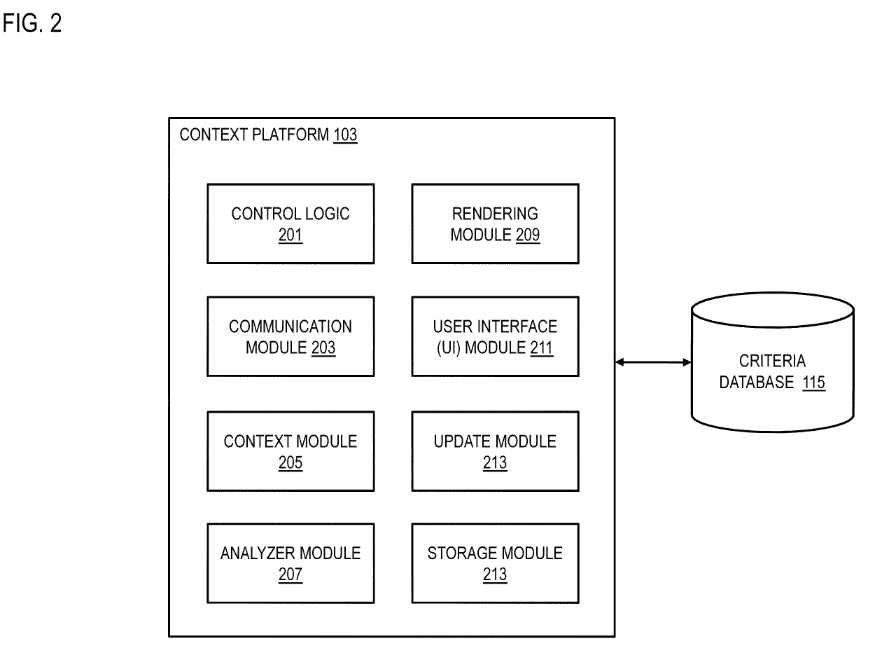

FIG. 2 is a diagram of the components of the context platform 103, according to one embodiment. By way of example, the context platform 103 includes one or more components for generating functional icons on one or more devices based on the location of one or more users relative to a user's vehicle, the time that the one or more users are away from the vehicle, and/or the specific location of the one or more users and/or the user's vehicle. It is contemplated that the functions of these components may be combined in one or more components or performed by other components of equivalent functionality. In this embodiment, the context platform 103 includes a control logic 201, a communication module 203, a context module 205, an analyzer module 207, a rendering module 209, a user interface (UI) module 211, an update module 213, and a storage module 215.

In one embodiment, the control logic 201 oversees tasks, including tasks performed by the communication module 203, the context module 205, the analyzer module 207, the rendering module 209, the UI module 211, the update module 213, and the storage module 215. For example, although the other modules may perform the actual task, the control logic 201 may determine when and how those tasks are performed or otherwise direct the other modules to perform the task.

The communication module 203 in certain embodiments is used for communication between the UEs 101, the context platform 103, the applications 107, the sensors 109, the at least one vehicle 111, the services 113, the criteria database 115, the services platform 117, the services 119, the content providers 121, and the satellites 123. The communication module 203 may also be used to communicate commands, requests, data, etc. In one embodiment, the communication module 203 is used to determine one or more credentials associated with the at least one vehicle, the at least one device, the at least one user, the one or more other users, or a combination thereof. For example, at least one user can register one or more credentials (e.g., a username and password) associated with at least one vehicle and at least one device (e.g., his or her mobile phone or tablet) on a single sign-on service that enables a user to access email, various applications and/or services, etc. and the communication module 203 can access the one or more credentials via the communication network 105.

In one embodiment, the context module 205, in connection with the communication module 203, is used to determine the one or more contextual parameters based, at least in part, on at least one notification transmitted by the at least one vehicle, one or more sensors associated with the at least one device, or a combination thereof. In particular, the at least one notification includes, at least in part, the location of the at least one vehicle (e.g., based on GPS coordinates), status information associated with the at least one vehicle that would enable the context module 205 to verify the presence of the at least one of user near the at least one vehicle (e.g., a lock status, a light status, an engine status, or a combination thereof), or a combination thereof. In addition, the context module 205 can determine the location of the at least one user relative to the at least one vehicle and/or the amount of time that the at least one user has spent away from the at least one vehicle based, at least in part, on the one or more sensors associated with the at least one device (e.g., a GPS receiver).

The analyzer module 207 in certain embodiments is used to cause, at least in part, an evaluation of one or more contextual parameters against one or more threshold criteria. In particular, the analyzer module 207, in connection with the context module 205, is used to evaluate whether the location of the at least one user relative to the location of the at least one vehicle, the amount of time that the at least one user exceeded the minimum distance, and/or the distance between the location of the at least one vehicle and another location of the at least one vehicle exceeds the minimum values of the one or more threshold criteria.

The analyzer module 207 may also be used to determine whether to generate the at least one interactive user interface element based, at least in part, on whether the one or more threshold criteria has been previously associated with the at least one user. For example, the analyzer module 207 may evaluate the location of the at least one vehicle against one or more locations stored in the criteria database 115 (e.g., one or more locations where the at least one user has parked the at least one vehicle a number of times in the past). The analyzer module 207 also may be used in connection with the context module 205 to cause, at least in part, a removal of the at least one interactive user interface element from the at least one user interface based, at least in part, on the evaluation, status information associated with the at least one vehicle, or a combination thereof. By way of example, if the analyzer module 207 determines that the one or more contextual parameters (e.g., the distance between the at least one user and the at least one vehicle) is less than the one or more threshold criteria (e.g., 50-100 meters), then the analyzer module 207 can automatically cause, at least in part, the removal of the at least one interactive user interface element from the at least one user interface.

In one or more embodiments, the rendering module 209, in connection with the analyzer module 207, is used to cause, at least in part, a generation of at least one interactive user interface element (e.g., a functional icon or live tile) depicting information related to the at least one vehicle, the at least one user, or a combination thereof based, at least in part, on the evaluation. By way of example, if the analyzer module 207 determines that the at least one user has exceeded one or more threshold criteria including, at least in part, a distance and a time (e.g., 50-100 meters and 5 minutes, respectively), the rendering module 209 can automatically cause, at least in part, the generation of the at least one interactive user interface element. In particular, the rendering module 209 can generate the at least one interactive user interface element as a map view, an address view, a picture view, or a combination thereof of the location of the at least one vehicle and the one or more views can be interchangeable. Moreover, in certain embodiments, the rendering module 209 may also include in the at least one interactive user interface element the remaining parking time if the maximum parking time is defined at the parking location and/or a current parking payment if a mobile parking payment is used. The rendering module 209 may also be used to cause, at least in part, a presentation of the at least one interactive user interface element in the at least one user interface of the at least one device. By way of example, the rendering module 209 may cause, at least in part, the presentation of the at least one interactive user interface element on the start screen or home screen of the at least one device. In addition, the rendering module 209 may also be used in connection with the UI module 211 to enable the at least one user to manipulate the size and/or location of the at least one interactive user interface element (e.g., by tapping or sliding the at least one interactive user interface element).

In one embodiment, the rendering module 207, in connection with the UI module 211, also may be used to cause, at least in part, a presentation of at least one mapping interface (e.g., a mapping and/or navigation application) depicting the location of the at least one vehicle based, at least in part, on at least one interaction with the at least one interactive user interface element. For example, if the UI module 211 determines a tapping or long press of the at least one interactive user interface element, then the rendering module 207 can cause, at least in part, a presentation of the at least one mapping interface to present to the at least one user various alternatives to reach the at least one vehicle (e.g., walking or taking a shuttle bus depending on the distance). The rendering module 207, in connection with the analyzer module 207, may also be used to cause, at least in part, a generation of at least one notification on the at least one device that the at least one user is near the at least one vehicle based, at least in part, on the evaluation.

The update module 213 in certain embodiments is used in connection with the context module 205 to cause, at least in part, at least one update of the one or more contextual parameters based, at least in part, on one or more other users moving the at least one vehicle. Once the update module 213 updates the one or more contextual parameters, the analyzer module 207 can reevaluate the one or more contextual parameters against the one or more threshold criteria to determine whether to generate at least one interactive user interface element on at least one device associated with the one or more other users and/or whether to cause, at least in part, a removal of the at least one interactive user interface element from the at least device of the at least one user.

In one embodiment, the storage module 215 is used to manage the storage of one or more lists of the one or more threshold criteria such as a minimum distance between at least one user and at least one vehicle (e.g., 50-100 meters), a minimum time for the at least one user to exceed the minimum distance (e.g., 5 minutes), a minimum distance between the original parking space and another location of the at least one vehicle (e.g., if the at least one vehicle is moved by one or more other users and is no longer near the at least one user), a location previously associated with the at least one user, a time of day, a weather condition, etc.

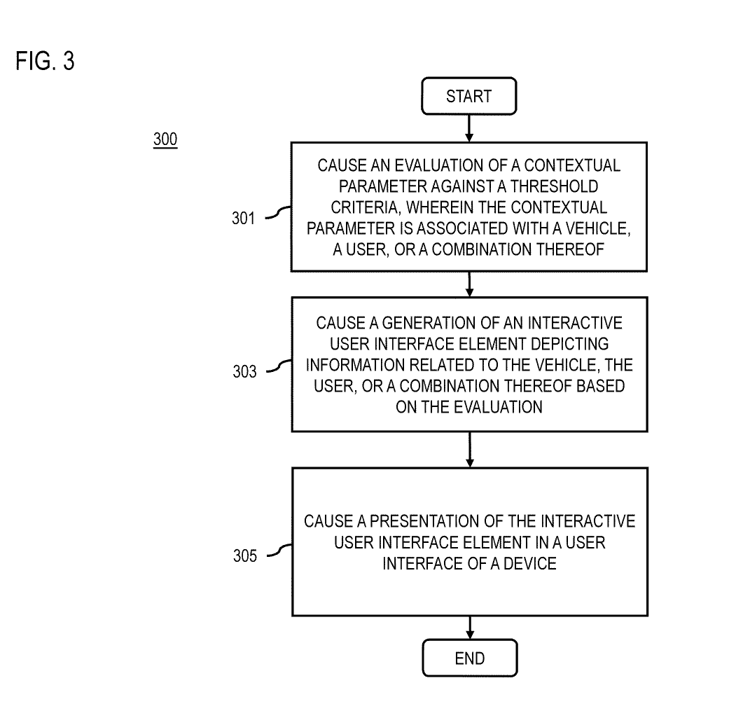

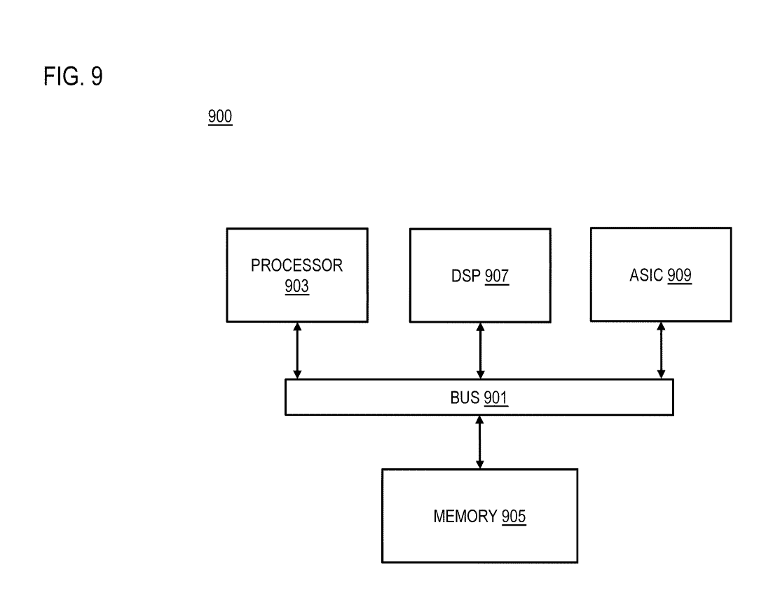

FIGS. 3-5 are flowcharts of processes for generating functional icons on one or more devices based on the location of one or more users relative to a user's vehicle, the time that the one or more users are away from the vehicle, and/or the specific location of the one or more users and/or the user's vehicle, according to one embodiment. In one embodiment, the context platform 103 performs the process 300 and is implemented in, for instance, a chip set including a processor and a memory as shown in FIG. 9. In step 301, the context platform 103 causes, at least in part, an evaluation of one or more contextual parameters against one or more threshold criteria, wherein the one or more contextual parameters are associated with at least one vehicle, at least one user of the at least one vehicle, or a combination thereof. By way of example, the one or more contextual parameters may include, at least in part, the location of the at least one vehicle, the location of the at least one user and/or the at least one device associated with the at least one user (e.g., a mobile phone or a tablet), the amount of time that the at least one user has spent apart or away from the at least one vehicle, the status information associated with the at least one vehicle, or a combination thereof. By way of further example, the one or more threshold criteria may include, at least in part, a minimum distance between the at least one vehicle and the at least one user (e.g., 50-100 meters), a minimum time for the at least one user to exceed the minimum distance (e.g., 5 minutes), a minimum distance between the location of the at least one vehicle and another location (e.g., if the vehicle is moved by one or more other users), a location previously associated with the at least one user (e.g., a home location, a reserved office space, etc.), a state of the one or more systems associated with the at least one vehicle, a low visibility condition (e.g., during the nighttime, fog, heavy rain, snow, etc.), specific geometric, architectural, and/or landscape-based details, or a combination thereof. Accordingly, in one embodiment, the context platform 103 evaluates whether the location of at least one user relative to the location of the at least one vehicle, the amount of time that the at least one user exceeded the minimum distance, and/or the distance between the location of the at least one vehicle and another location exceeds the minimum values of the at least one or more threshold criteria.

In step 303, the context platform 103 causes, at least in part, a generation of at least one interactive user interface element depicting information related to the at least one vehicle, the at least one user, or a combination thereof based, at least in part, on the evaluation. In one embodiment, the at least one interactive user interface element is a functional icon, a live tile, a widget, etc. In one example use case, the information related to the at least one vehicle includes, at least in part, the location of the vehicle (e.g., a location in a parking lot). More specifically, if the context platform 103 determines that the at least one user has exceeded one or more threshold criteria including, at least in part, a distance and a time (e.g., 50-100 meters and 5 minutes, respectively), the context platform 103 can automatically cause, at least in part, the generation of the at least one interactive user interface element (e.g., a functional icon or a live tile). In contrast, if the context platform 103 determines that the at least one user is a sufficient distance away from the at least one vehicle, but leaves the one or more doors unlocked, for example, then the context platform 103 will not cause, at least in part, the generation of the at least one interactive user interface element since it is presumed that the at least one user is returning to the at least one vehicle shortly and is unlikely to need navigation assistance. In one embodiment, the at least one interactive user interface element may include, at least in part, a map view, an address view, a picture view, or a combination thereof of the location of the at least one vehicle and the one or more views can be interchangeable (e.g., based on user preference). In one embodiment, it is contemplated that the at least one interactive use interface element may also include the remaining parking time if the maximum parking time is defined and/or the current parking payment if a mobile parking payment is used.

In step 305, the context platform 103 causes, at least in part, a presentation of the at least one interactive user interface element in at least one user interface of at least one device. By way of example, the context platform 103 can cause, at least in part, the presentation of the at least one interactive user interface element on a start screen or home screen of the at least one device (e.g. a mobile phone or a tablet). In one embodiment, the context platform 103 can cause, at least in part, a presentation of the at least one interactive user interface element in each device “paired” with the at least one vehicle. For example, if the context platform 103 determines that the at least one user (e.g., user “A”) is standing next to the at least one vehicle, then the context platform 103 will not cause, at least in part, the presentation of the at least interactive user interface element on his or her device. However, if the context platform 103 also determines that one or more other users (e.g., user “B” that shares and/or has access to the at least one vehicle) has passed the minimum distance for the minimum time, then the context platform 103 will cause, at least in part, the presentation of the at least one interactive user interface element in at least one user interface of at least one device of user “B”. In one or more embodiments, it is contemplated that context platform 103 can enable the at least one user to manipulate the size and/or location of the at least one interactive user interface element on the at least one user interface (e.g., by tapping or sliding the at least one interactive user interface element).

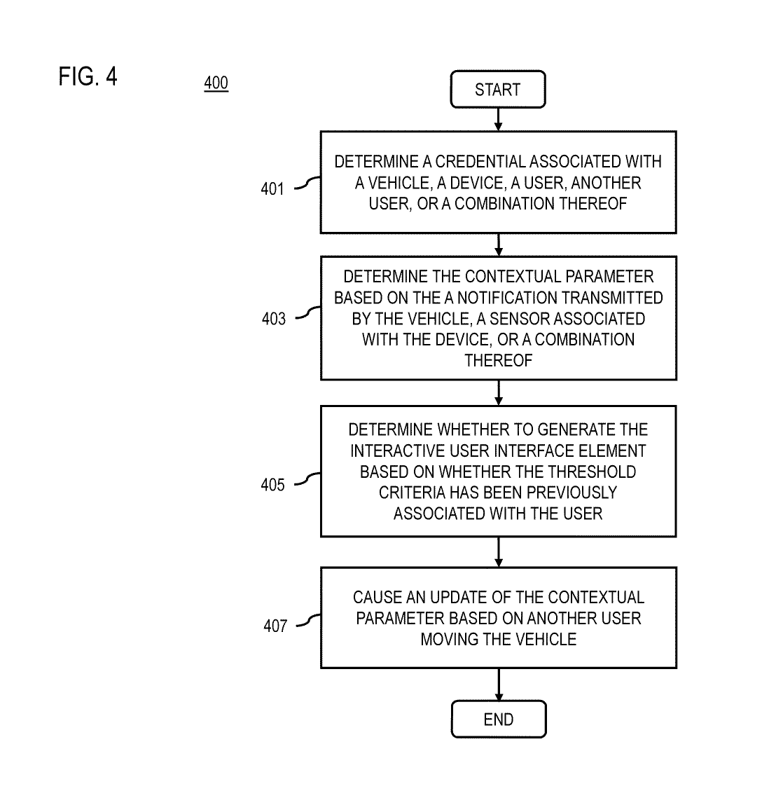

FIG. 4 depicts a process 400 of determining the one or more contextual parameters, the one or more threshold criteria, or a combination thereof. In one embodiment, the context platform 103 performs the process 400 and is implemented in, for instance, a chip set including a processor and a memory as shown in FIG. 9. In step 401, the context platform 103 determines one or more credentials associated with the at least one vehicle, the at least one device, the at least one user, the one or more other users, or a combination thereof, wherein the generation of the at least one interactive user interface element is further based, at least in part, on the determination of the one or more credentials. By way of example, at least one user can register one or more credentials (e.g., a username and password) associated with the at least one vehicle and at least one device (e.g., a mobile phone or a tablet) on a single sign-on service that enables a user to access an email account, various applications and/or services, etc. and the context platform 103 can thereafter determine that the at least one vehicle and the at least one device are “paired.” Moreover, the at least one user can also register one or more credentials associated with one or more other users that may also use the at least one vehicle from time to time (e.g., a family member or close friend of the at least one user).

In step 403, the context platform 103 determines the one or more contextual parameters based, at least in part, on at least one notification transmitted by the at least one vehicle, one or more sensors associated with the at least one device, or a combination thereof, wherein the at least one notification includes, at least in part, a location of the at least one vehicle, the status information associated with the at least one vehicle, or a combination thereof. As previously discussed, the one or more contextual parameters may include, at least in part, the location of the at least one vehicle, the location of the at least one user and/or the at least one device associated with the at least one user, the amount of time that the at least one user has spent apart or away from the at least one vehicle, the status information associated with the at least one vehicle (e.g., a lock status, a light status, an engine status, etc.), or a combination thereof. In one embodiment, the at least one notification includes, at least in part, the location of the at least one vehicle (e.g., GPS coordinates), the status information, or a combination thereof. By way of example, when the at least one user parks the at least one vehicle, the vehicle, one or more services associated with the at least one vehicle (e.g., a communication service, a navigation service, or a combination thereof), or a combination thereof can notify the context platform 103 of the vehicle's location (e.g., parked within a large shopping mall parking lot) and its status (e.g., locked doors) via the communication network 105. In one embodiment, it is contemplated that the at least one vehicle, the one or more services associated with the at least one vehicle, or a combination thereof can also notify the context platform 103 of a change in the status of one or more systems associated with the vehicle and thereby verify the presence of the at least one user near the at least one vehicle. In one embodiment, the context platform 103 can determine the location of the at least one user and how long he or she has spent away from the at least one vehicle based, at least in part, on the one or more sensors associated with the at least one device (e.g., a GPS receiver). By way of example, in terms of time, the context platform 103 can determine whether the at least one user has been away from the at least one vehicle for a considerable amount of time (e.g., while shopping in a shopping mall) or for a short period of time (e.g., running into a convenience store to only make a quick purchase before getting back into the at least one vehicle).

In step 405, the context platform 103 determines whether to generate the at least one interactive user interface element based, at least in part, on whether the one or more threshold criteria has been previously associated with the at least one user. For example, if the context platform 103 determines that the at least one user has parked the at least one vehicle 10 times or more, for example, in the same location (e.g., a home location, a reserved parking spot at work, etc.), then the context platform 103 will not cause, at least in part, the generation of the at least one interactive user interface element because it is contemplated that the user is unlikely to forget where he or she parked his or her vehicle. In particular, the association information is only valid for that specific user. For example, when the context platform 103 determines that a user “A” has parked the at least one vehicle at his or her home location, the context platform 103 will not cause, at least in part, the generation of the at least one interactive user interface element. However, when the context platform 103 determines that a user “B” has parked the at least one vehicle at this same location, the context platform 103 can cause, at least in part, the generation of the at least one interactive user interface element on the at least one user interface of at least one device of user “B”.

In step 407, the context platform 103 causes, at least in part, at least one update of the one or more contextual parameters based, at least in part, on one or more other users moving the at least one vehicle. In one example use case, once the at least one user first parks the at least one vehicle (e.g., in a large office complex parking lot), the context platform 103 can determine a notification from the at least one vehicle including, at least in part, the location of the vehicle. The context platform 103 then evaluates and determines whether the one or more contextual parameters (e.g., a distance and a time) exceed the one or more threshold criteria (e.g., 50-100 meters and 5 minutes, respectively). If so, the context platform 103 then causes, at least in part, the generation of the at least one interactive user interface element (e.g., a functional icon or a live tile) on the at least one user interface of the at least one device (e.g., a start screen of a mobile phone). After some time, the context platform 103 may determine one or more credentials of one or more other users (e.g., a family member) and/or that the minimum distance between the initial location of the at least one vehicle and another location has been exceeded (e.g., if the at least one vehicle is moved by one or more other users), the context platform 103 can cause, at least in part, the removal of the at least one interactive user interface element from the at least one device of the at least one user and once the one or more users park the at least one vehicle, the context platform 103 can update the at one or more contextual parameters and restart the process disclosed herein (i.e., substituting the one or more other users for the at least one user).

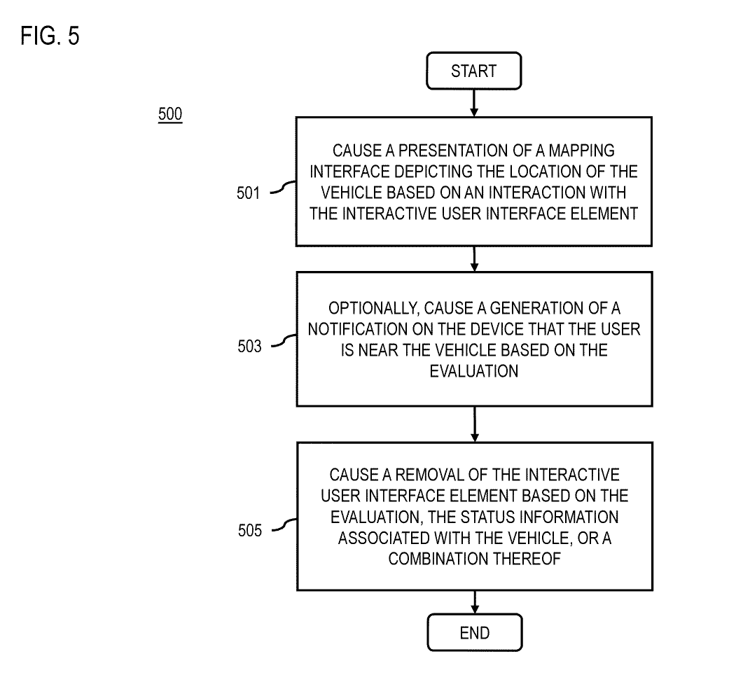

FIG. 5 depicts a process 500 of providing the at least one user navigation assistance to the at least one vehicle and removing the at least one interactive user interface element. In one embodiment, the context platform 103 performs the process 500 and is implemented in, for instance, a chip set including a processor and a memory as shown in FIG. 9. In step 501, the context platform 103 causes, at least in part, a presentation of at least one mapping interface depicting the location of the at least one vehicle based, at least in part, on at least one interaction with the at least one interactive user interface element. By way of example, the context platform 103 can cause, at least in part, the at least one mapping interface to present to the at least one user various alternative routes to reach the at least one vehicle (e.g., a walking route) based, at least in part, on at least one interaction with the at least one interactive user interface element (e.g., a tapping on the interface element). In one embodiment, the context platform 103 can also cause, at least in part, the at least one mapping interface to present to the at least one user public transportation or drive navigation assistance to the at least one vehicle as well (e.g., if the at least one vehicle has been moved by the one or more other users and is no longer near the at least one user).

In step 503, the context platform 103 optionally causes, at least in part, a generation of at least one notification on the at least one device that the at least one user is near the at least one vehicle based, at least in part, on the evaluation of the one or more contextual parameters against the one or more threshold criteria. By way of example, the at least one notification may include, at least in part, a visual prompt, an audio prompt, a haptic prompt (e.g., a vibration), or a combination thereof. In one example use case, the context platform 103 can notify the at least one user that he or she has arrived at his or her vehicle and can then cause, at least in part, the at least one mapping interface to close since the navigation assistance is no longer needed by the at least one user.

In step 505, the context platform 103 causes, at least in part, a removal of the at least one interactive user interface element from the at least one user interface based, at least in part, on the evaluation, status information associated with the at least one vehicle, or a combination thereof. By way of example, the status information is based, at least in part, on the location of the at least one vehicle, one or more systems associated with the at least one vehicle (e.g., locks, lights, an engine, etc.), or a combination thereof. In one embodiment, if the context platform 103 determines that the one or more contextual parameters (e.g., the distance between the at least one user and the at least one vehicle) is less than the one or more threshold criteria (e.g., 50-100 meters), then the context platform 103 can automatically remove the at least one interactive user interface element (e.g., a functional tile or a live tile) from the at least one user interface of the at least one device (e.g., a start screen or home screen of a mobile phone or a tablet). Similarly, if the context platform 103 determines a change in the status information (e.g., one or more doors being unlocked), then the context platform 103 can verify that the at least one user is near the at least one vehicle and therefore no longer needs the at least one interactive user interface element. In one example use case, it is contemplated that the even if the system 100 determines that the at least one user has closed the at least one mapping interface (e.g., while running into a store) and/or has returned to the start screen or home screen of the at least one device, for example, the at least one interactive user interface element (e.g., a functional icon or a live tile) will remain in the at least one user interface of the at least one device.

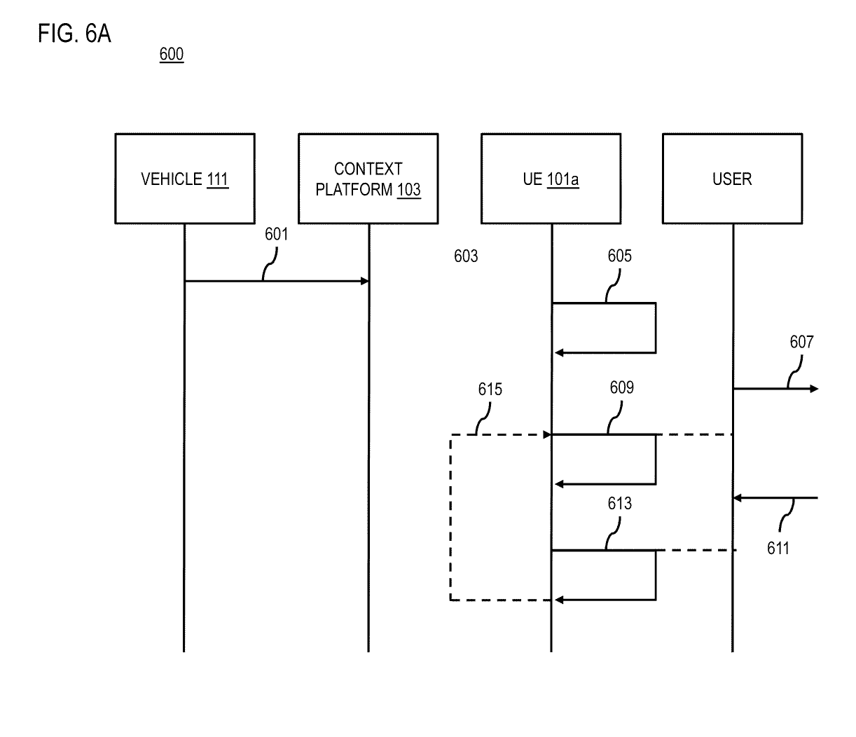

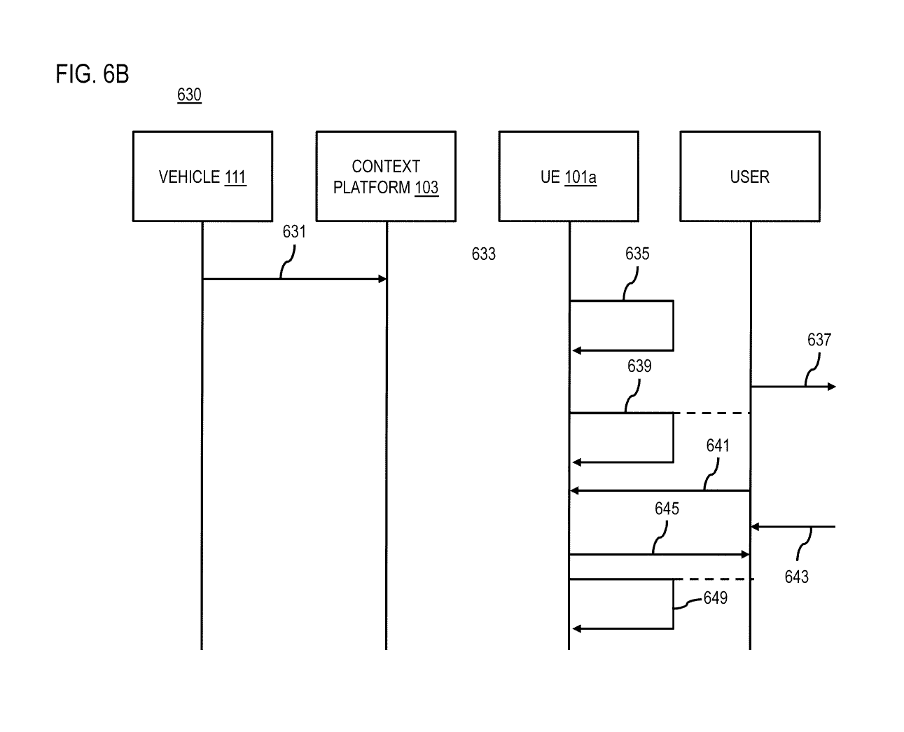

FIGS. 6A and 6B are ladder diagrams that illustrate processes for generating functional icons on one or more devices based on the location of one or more users relative to a user's vehicle, the time that the one or more users are away from the vehicle, or a combination thereof, according to one embodiment, according to various embodiments. FIG. 6A depicts a process flow without any interaction on the part of at least one user. More specifically, the processes in the diagram 600 include at least one vehicle (e.g., the vehicle 111), a cloud service (e.g., the context platform 103), at least one user device (e.g., the UE 101a), and at least one user. A network process is represented by a thin vertical line. A step or message passed from one element to another is represented by horizontal lines. In this example use case, the context platform 103 has already determined that the vehicle 111 and the UE 101a are “paired” based, at least in part, on the one or more credentials determined by the context platform 103. In step 601, the context platform 103 determines one or more contextual parameters associated with the at least one vehicle based, at least in part, on the at least one notification from the vehicle 111, wherein the at least one notification includes, at least in part, a location of the vehicle 111, status information associated with the vehicle 111 (e.g., doors locked), or a combination thereof. In step 603, the context platform 103 causes, at least in part, a generation of at least one interactive user interface element (e.g., a functional icon or a live tile) depicting information related to the vehicle 111 (e.g., the vehicle's location). In step 605, the context platform 103 processes and/or facilitates a processing of the location information in related local services (e.g., a mapping and/or navigation service).

In step 607, the context platform 103 determines that the at least one user has moved away from the vehicle 111 based, at least in part, on one or more sensors associated with the UE 101a (e.g., a GPS receiver). If the context platform 103, determines that the one or more contextual parameters associated with the at least one user exceed the one or more threshold criteria (e.g., the at least one user has moved 50-100 meters from the vehicle 111 for at least 5 minutes), then in step 609, the context platform 103 causes, at least in part, a presentation of the at least one interactive user interface element in at least one user interface of the UE 101a. Next, in step 611, the context platform 103 determines that the at least one user is moving towards the vehicle 111 based, at least in part, on the one or more sensors associated with the UE 101a. In step 613, the context platform 103 causes, at least in part, a removal of the at least one interactive user interface element based, at least in part, on the evaluation of the one or more contextual parameters against the one or more threshold criteria. The dashed step 615 illustrates that in one embodiment either the context platform 103 or the UE 101a can cause, at least in part, the generation of the at least one interactive user interface element.

FIG. 6B depicts a process flow where the at least one user interacts with the at least one interactive user interface element (e.g., a functional icon or a live tile) to start at least one mapping interface to navigate back to the at least one vehicle. The processes in the diagram 630 also include at least one vehicle (e.g., the vehicle 111), a cloud service (e.g., the context platform 103), at least one user device (e.g., the UE 101a), and at least one user. In this example use case, the context platform 103 has again already determined that the vehicle 111 and the UE 101a are “paired” based, at least in part, on the one or more credentials determined by the context platform 103. Moreover, the steps 631-639 of FIG. 6B are identical to the steps 601-609 of FIG. 6A. However, in step 641 the context platform 103 causes, at least in part, a presentation of at least one mapping interface depicting the location of the vehicle 111 based, at least in part, on at least one interaction with the at least one interactive user interface element (e.g., a tapping on the interface element). Similar to step 611 of FIG. 6A, in step 643, the context platform 103 determines that the at least one user is again moving towards the vehicle 111 based, at least in part, on one or more sensors associated with the UE 101a. In step 645, the context platform 103 causes, at least in part, a generation of at least one notification on the UE 101a (e.g., a visual prompt, an audio prompt, a haptic prompt, or a combination thereof) that the at least one user is near the vehicle 111. Then, in step 649, the context platform 103 causes, at least in part, the removal of the at least one interactive user interface element based, at least in part, on the evaluation of the at one or more contextual parameters against the one or more threshold criteria (e.g., the distance of the at least one user to the vehicle 111 is less than 50-100 meters).

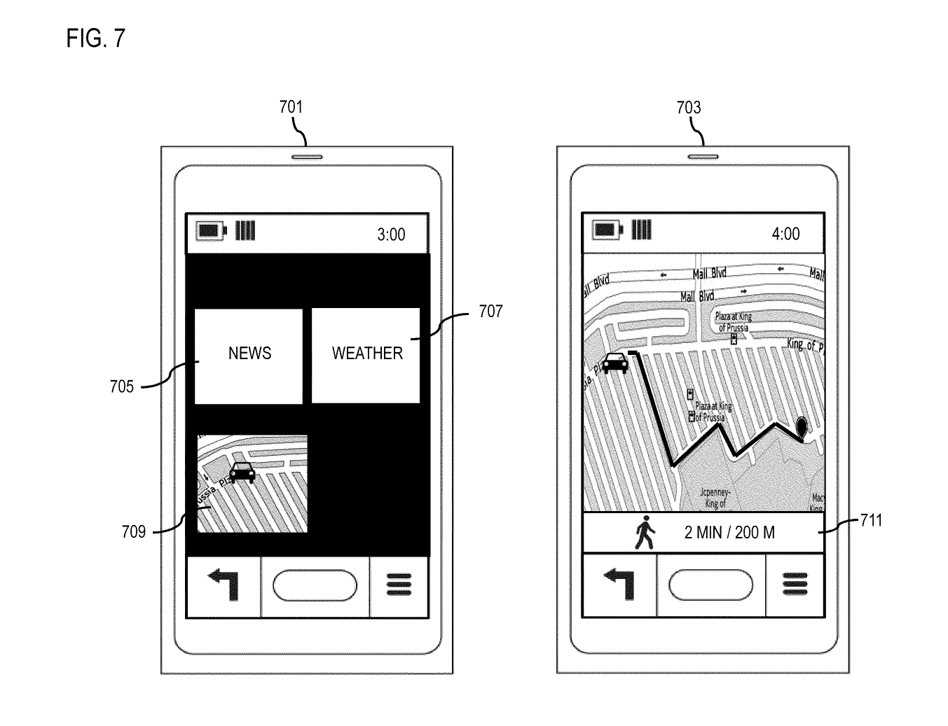

FIG. 7 is a diagram of user interfaces utilized in the processes of FIGS. 3-5, according to various embodiments. As shown, the example user interfaces of FIG. 7 include one or more user interface elements and/or functionalities created and/or modified based, at least in part, on information, data, and/or signals resulting from the processes (e.g., 300, 400, and 500) described with respect to FIGS. 3-5. More specifically, FIG. 7 illustrates two user interfaces (e.g., interfaces 701 and 703) depicting information related to at least one vehicle (e.g., the vehicle 111) parked in a large shopping mall complex. Moreover, the interface 701 depicts two interactive user interface elements (e.g., functional icons or live tiles 705 and 707 depicting real-time information relating to news and weather, respectively).

In this example use case, the system 100 has already caused, at least in part, a generation of another interactive user interface element (e.g., the functional icon or live tile 709) depicting information related to at least one vehicle (e.g., a map view of the vehicle's location in the shopping mall parking lot) based, at least in part, on the evaluation of one or more contextual parameters against one or more threshold criteria. For example, at 3:00 p.m., the at least one user had walked over 50-100 meters away from the at least one vehicle and has been away from the at least one vehicle at that distance for over 5 minutes. In one embodiment, when the at least one user has completed his or her shopping (e.g., at 4:00 p.m. as depicted in the interface 703), the system 100 can cause, at least in part, a presentation of at least one mapping interface depicting the location of the least one vehicle (e.g., as shown in the interface 703) based, at least in part, on at least one interaction with the at least one interactive user interface element 709 of interface 701 (e.g., by tapping the functional icon or live tile 709). In this example use case, the system 100 can cause, at least in part, the at least one mapping interface of the interface 703 to present to the at least one user a navigation route (e.g., by walking) to reach the at least one vehicle. In addition, in one embodiment, the system 100 can present to the at least one user the distance and estimated time that it will take the at least one use to reach the at least one vehicle as depicted in the dialogue box 711. As previously discussed, once the system 100 determines that the one or more contextual parameters (e.g., the distance between the at least one user and the at least one vehicle) are less than the one or more threshold criteria (e.g., 50-100 meters), then the system 100 can automatically remove the interactive user interface element 709 from the start screen or home screen of the interface 701 leaving only the functional icons or live tiles 705 and 707.

The processes described herein for generating functional icons on one or more devices based on the location of one or more users relative to a user's vehicle, the time that the one or more users are away from the vehicle, and/or the specific location of the one or more users and/or the user's vehicle may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

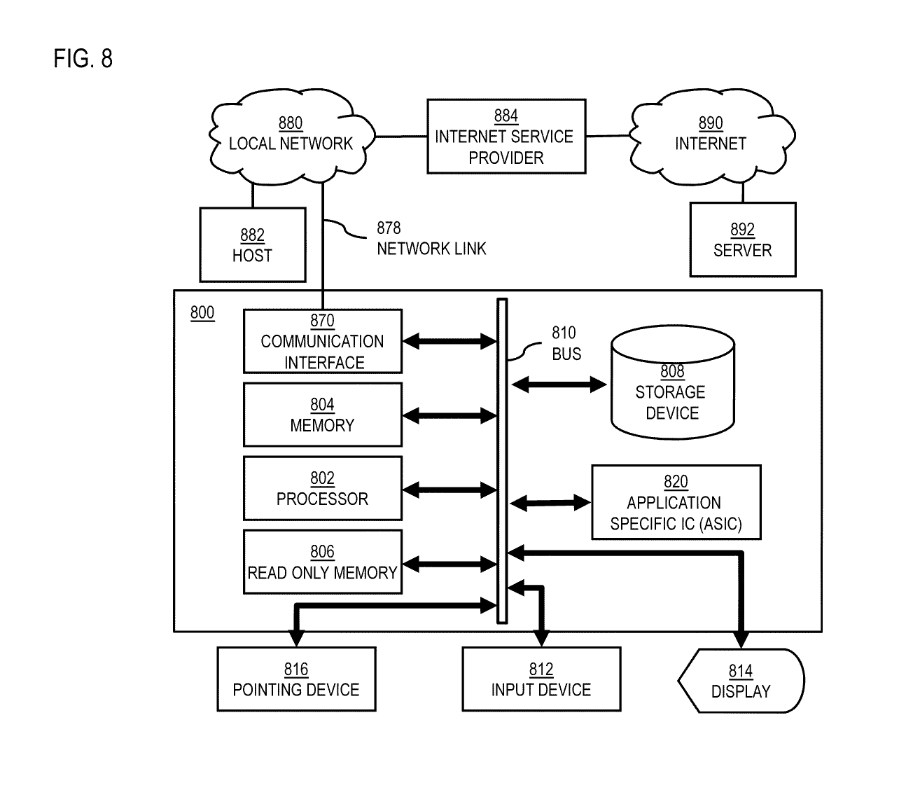

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to generate functional icons on one or more devices based on the location of one or more users relative to a user's vehicle, the time that the one or more users are away from the vehicle, and/or the specific location of the one or more users and/or the user's vehicle as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of generating functional icons on one or more devices based on the location of one or more users relative to a user's vehicle, the time that the one or more users are away from the vehicle, and/or the specific location of the one or more users and/or the user's vehicle.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to generate functional icons on one or more devices based on the location of one or more users relative to a user's vehicle, the time that the one or more users are away from the vehicle, and/or the specific location of the one or more users and/or the user's vehicle. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for generating functional icons on one or more devices based on the location of one or more users relative to a user's vehicle, the time that the one or more users are away from the vehicle, and/or the specific location of the one or more users and/or the user's vehicle. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for generating functional icons on one or more devices based on the location of one or more users relative to a user's vehicle, the time that the one or more users are away from the vehicle, and/or the specific location of the one or more users and/or the user's vehicle, is provided to the bus 810 for use by the processor from an external input device 812, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 for generating functional icons on one or more devices based on the location of one or more users relative to a user's vehicle, the time that the one or more users are away from the vehicle, and/or the specific location of the one or more users and/or the user's vehicle to the UEs 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to generate functional icons on one or more devices based on the location of one or more users relative to a user's vehicle, the time that the one or more users are away from the vehicle, and/or the specific location of the one or more users and/or the user's vehicle as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of generating functional icons on one or more devices based on the location of one or more users relative to a user's vehicle, the time that the one or more users are away from the vehicle, and/or the specific location of the one or more users and/or the user's vehicle.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to generate functional icons on one or more devices based on the location of one or more users relative to a user's vehicle, the time that the one or more users are away from the vehicle, and/or the specific location of the one or more users and/or the user's vehicle. The memory 905 also stores the data associated with or generated by the execution of the inventive steps.

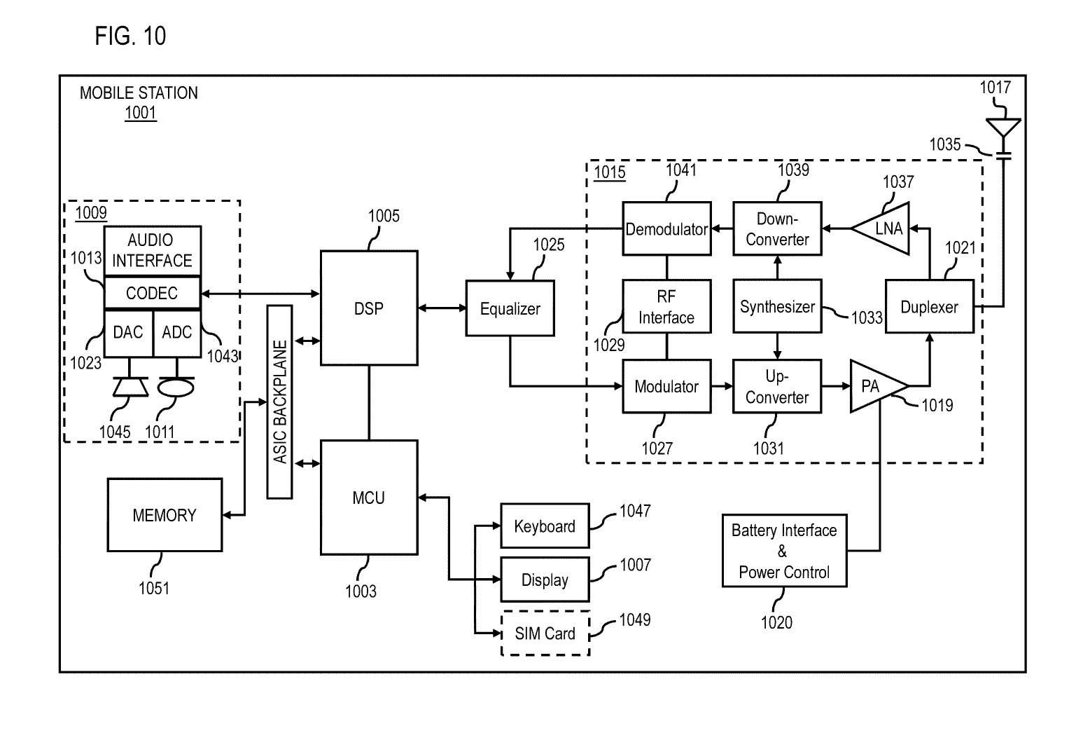

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of generating functional icons on one or more devices based on the location of one or more users relative to a user's vehicle, the time that the one or more users are away from the vehicle, and/or the specific location of the one or more users and/or the user's vehicle. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of generating functional icons on one or more devices based on the location of one or more users relative to a user's vehicle, the time that the one or more users are away from the vehicle, and/or the specific location of the one or more users and/or the user's vehicle. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to generate generating functional icons on one or more devices based on the location of one or more users relative to a user's vehicle, the time that the one or more users are away from the vehicle, and/or the specific location of the one or more users and/or the user's vehicle. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising facilitating a processing of and/or processing (1) data and/or (2) information and/or (3) at least one signal, the (1) data and/or (2) information and/or (3) at least one signal based, at least in part, on the following:
an evaluation of one or more contextual parameters against one or more threshold criteria, wherein the one or more contextual parameters are associated with at least one vehicle, at least one user of the at least one vehicle, or a combination thereof;
a generation of at least one interactive user interface element depicting information related to the at least one vehicle, the at least one user, or a combination thereof based, at least in part, on the evaluation; and
a presentation of the at least one interactive user interface element in at least one user interface of at least one device.

2. A method of claim 1, wherein the (1) data and/or (2) information and/or (3) at least one signal are further based, at least in part, on the following:
a removal of the at least one interactive user interface element from the at least one user interface based, at least in part, on the evaluation, status information associated with the at least one vehicle, or a combination thereof.

3. A method of claim 1, wherein the at least one user interface element is a live tile, an icon, a widget, or a combination thereof.

4. A method of claim 1, wherein the (1) data and/or (2) information and/or (3) at least one signal are further based, at least in part, on the following:
at least one determination of the one or more contextual parameters based, at least in part, on at least one notification transmitted by the at least one vehicle, one or more sensors associated with the at least one device, or a combination thereof,
wherein the at least one notification includes, at least in part, a location of the at least one vehicle, the status information associated with the at least one vehicle, or a combination thereof.

5. A method of claim 1, wherein the (1) data and/or (2) information and/or (3) at least one signal are further based, at least in part, on the following:
a presentation of at least one mapping interface depicting the location of the at least one vehicle based, at least in part, on at least one interaction with the at least one interactive user interface element.

6. A method of claim 1, wherein the (1) data and/or (2) information and/or (3) at least one signal are further based, at least in part, on the following:
at least one determination of whether to generate the at least one interactive user interface element based, at least in part, on whether the one or more threshold criteria has been previously associated with the at least one user.

7. A method of claim 1, wherein the (1) data and/or (2) information and/or (3) at least one signal are further based, at least in part, on the following:
at least one update of the one or more contextual parameters based, at least in part, on one or more other users moving the at least one vehicle.

8. A method of claim 1, wherein the (1) data and/or (2) information and/or (3) at least one signal are further based, at least in part, on the following:
a generation of at least one notification in the at least one user interface that the at least one user is near the at least one vehicle based, at least in part, on the evaluation.

9. A method of claim 1, wherein the (1) data and/or (2) information and/or (3) at least one signal are further based, at least in part, on the following:
at least one determination of one or more credentials associated with the at least one vehicle, the at least one device, the at least one user, the one or more other users, or a combination thereof,
wherein the generation of the at least one interactive user interface element is further based, at least in part, on the determination of the one or more credentials.

10. A method of claim 2, wherein the status information is based, at least in part, on the location of the at least one vehicle, one or more systems associated with the at least one vehicle, or a combination thereof.

11. An apparatus comprising:
at least one processor; and
at least one memory including computer program code for one or more programs,
the at least one memory and the computer program code configured to, with the at least one processor, cause the apparatus to perform at least the following,
cause, at least in part, an evaluation of one or more contextual parameters against one or more threshold criteria, wherein the one or more contextual parameters are associated with at least one vehicle, at least one user of the at least one vehicle, or a combination thereof;
cause, at least in part, a generation of at least one interactive user interface element depicting information related to the at least one vehicle, the at least one user, or a combination thereof based, at least in part, on the evaluation; and
cause, at least in part, a presentation of the at least one interactive user interface element in at least one user interface of at least one device.

12. An apparatus of claim 11, wherein the apparatus is further caused to:
cause, at least in part, a removal of the at least one interactive user interface element from the at least one user interface based, at least in part, on the evaluation, status information associated with the at least one vehicle, or a combination thereof.

13. An apparatus of claim 11, wherein the at least one user interface element is a live tile, an icon, a widget, or a combination thereof.

14. An apparatus of claim 11, wherein the apparatus is further caused to:
determine the one or more contextual parameters based, at least in part, on at least one notification transmitted by the at least one vehicle, one or more sensors associated with the at least one device, or a combination thereof,
wherein the at least one notification includes, at least in part, a location of the at least one vehicle, the status information associated with the at least one vehicle, or a combination thereof.

15. An apparatus of claim 11, wherein the apparatus is further caused to:
cause, at least in part, a presentation of at least one mapping interface depicting the location of the at least one vehicle based, at least in part, on at least one interaction with the at least one interactive user interface element.

16. An apparatus of claim 11, wherein the apparatus is further caused to:
determine whether to generate the at least one interactive user interface element based, at least in part, on whether the one or more threshold criteria has been previously associated with the at least one user.

17. An apparatus of claim 11, wherein the apparatus is further caused to:
cause, at least in part, at least one update of the one or more contextual parameters based, at least in part, on one or more other users moving the at least one vehicle.

18. An apparatus of claim 11, wherein the apparatus is further caused to:
cause, at least in part, a generation of at least one notification in the at least one user interface that the at least one user is near the at least one vehicle based, at least in part, on the evaluation.

19. An apparatus of claim 11, wherein the apparatus is further caused to:
determine one or more credentials associated with the at least one vehicle, the at least one device, the at least one user, the one or more other users, or a combination thereof,
wherein the generation of the at least one interactive user interface element is further based, at least in part, on the determination of the one or more credentials.

20. A method of claim 12, wherein the status information is based, at least in part, on the location of the at least one vehicle, one or more systems associated with the at least one vehicle, or a combination thereof.

21.-48. (canceled)
